(19) United States
(12) Patent Application Publication
(10) Pub. No.: US 2012/0091070 A1
(43) Pub. Date: Apr. 19, 2012

(54) Multi-Stage Water Treatment and Enrichment Method and Apparatus

(76) Inventors: Bernard Sjauta, Mission Viejo, CA (US); Grace Hung, Mission Viejo, CA (US)

(21) Appl. No.: 13/096,962

(22) Filed: Apr. 28, 2011

Related U.S. Application Data
(60) Provisional application No. 61/393,924, filed on Oct. 17, 2010.

(51) Int. Cl. C02F 9/08; B01D 27/14; C02F 101/00; C02F 103/04

(52) U.S. Cl. 210/764; 210/203; 210/206; 210/202

(57) ABSTRACT

Some embodiments provide a multi-stage water treatment and enrichment apparatus with an upper water reservoir, a lower water reservoir, a cartridge that is composed of a porous filter and multiple seep through chambers that treat and enrich water, a water dispensing tap valve, and a preservation cartridge. Collectively, these components function (1) to provide multiple levels of treatment including filtration and purification, (2) to provide enrichment of water via mineralization, magnetization, softening, and alkalinization, (3) to provide for customizability of the treatment and enrichment so that different consumers can adapt these processes to satisfy their own personal preferences, (4) to provide an apparatus that operates using gravitational forces and without the need for external power or pressure to perform the multi-stage treatment and enrichment of water, and (5) to provide an inexpensive apparatus that is suitable for primary usage in the home.

### CLAIM OF BENEFIT TO RELATED APPLICATIONS

This application claims the benefit of U.S. Provisional Application 61/393,924 entitled “Water Treatment Apparatus & Method of Use Thereof”, filed Oct. 17, 2010.

### TECHNICAL FIELD

The present invention relates generally to the field of water treatment. Moreover, it pertains specifically to a water treatment and enrichment apparatus that will transform common tap water into healthy mineralized magnetized purified drinking water.

### BACKGROUND

It is well understood that untreated water can contain a wide variety of contaminants that can cause illness if consumed. These contaminants include various microorganisms (e.g., parasites, bacteria, pathogens, etc.), disinfection byproducts (e.g., bromate, chlorite, etc.), disinfectants (e.g., chlorine, chloramines, etc.), inorganic chemicals (e.g., arsenic, cadmium, lead, mercury, etc.), organic chemicals (e.g., tetrachloroethylene, trichloroethylene, etc.), and radionuclides (e.g., alpha and beta particles). A more complete listing of common drinking water contaminants is provided at the United States Environmental Protection Agency website.

Most of the water we consume is treated to remove harmful levels of these and other contaminants. Treated drinking water is readily obtainable from various sources including tap water, tap water that is further treated at the home with personal water filtration systems, and commercially treated drinking water. Tap water is usually treated at municipal water departments. Nevertheless, tap water has been shown to contain small levels of contaminants that are a result of the treatment of the water, the delivery of the water through pipes, and contaminant regrowth. For instance, chlorine is a highly efficient disinfectant that is used to treat tap water and kill harmful bacteria that are contained in the untreated water or pipes that carry the water. However, remnants of chlorine in the tap water can be harmful to humans when consumed in sufficiently high quantities or consumed over a long period of time. Additionally, the chlorine can react with materials in the pipes that carry the water to form other harmful contaminants such as trihalomethanes.

Accordingly, many people use personal water filtration systems to further treat tap water. Personal water filtration systems treat water in one of two ways: filtration and purification. Purification often involves passing water through activated carbon particles or ion exchange resins. These techniques have been shown to effectively remove 93-99% of contaminants from water. Personal water filtration systems include (1) inexpensive water filters such as Brita® filtration pitchers and faucet filtration and (2) more expensive personal water filtration systems such as Culligan® drinking water systems.

Some consumers prefer commercially treated water instead of tap water or water that has been treated with personal water filtration systems, because of the belief that commercially treated water is more pure. Furthermore, some consumers prefer commercially treated water, because the water is enriched with minerals and other elements. Some minerals have been proven to be beneficial to one's health, whereas some other minerals are only believed to be beneficial to one's health. Minerals can also be used to alter the taste of water. To distinguish commercially treated water from the treated water that is obtained from the above described personal water filtration systems, commercially treated water is often marketed as “mineral water” or “enriched water” to highlight the presence of the minerals within the water.

One of the downsides to commercially treated water is that the water is brought to market using plastic bottles. Not only do these bottles produce excessive waste, these bottles can over time reintroduce harmful contaminants into the treated water. Specifically, many of these bottles are created from petroleum based plastics. These plastics contain Bisphenol A or BPA which is an organic compound with estrogenic properties. When exposed to heat, the BPA from the plastic can begin to seep into the water thereby contaminating the water with this harmful compound.

Currently, there is no effective and inexpensive personal water filtration system that filters, purifies, and enriches water. Accordingly, there is a need for a personal water treatment and enrichment apparatus that filters, purifies, and enriches water. There is a need to allow for different and combinable forms of enrichment including mineral enrichment, magnetization, alkalinity balancing, and water softness balancing.

### SUMMARY OF THE INVENTION

Some embodiments provide a new and useful multi-stage water treatment and enrichment method and apparatus for the filtration, purification, mineralization, magnetization, and preservation of water, which is simpler in construction, more universally usable, and more versatile in operation than other personal water filtration systems. The apparatus generally comprises an upper water reservoir, a lower water reservoir, a treatment and enrichment cartridge, a water dispensing tap valve, and a preservation cartridge.

The upper water reservoir acts as a receptacle for receiving untreated water, tap water, well water, rain water, reclaimed water, reuse water or other types of potable water. The upper water reservoir has an opening near the center of its bottom face that allows the water to pass from the upper water reservoir to the treatment and enrichment cartridge.

In some embodiments, the cartridge is comprised of a porous pass through ceramic filter and a set of chambers containing different particles for purifying and enriching water. The pores of the ceramic filter are of a specified size to trap contaminants exceeding the specified size of the pores without blocking the passage of water through the pores. In some embodiments, the ceramic filter is detachable from the remainder of the cartridge so that the pores of the ceramic filter can be cleaned at periodic intervals to maintain proper water flow through the filter. The ceramic filter can be washed or scrubbed to remove the contaminants trapped along the outer surface of the ceramic filter. Each time the ceramic filter is cleaned, a layer of ceramic is removed, and a new clean layer of ceramic is exposed.

Filtered water passes through the ceramic filter to the treatment and enrichment cartridge. The treatment and enrichment cartridge is composed of various separated chambers. Each chamber of the cartridge performs one of water purification and water enrichment. More specifically, each chamber can perform a different type of purification or enrichment including different types of mineralization. In some embodiments, a first cartridge chamber performs water purification. The first chamber contains particles of activated carbon or particles of silver impregnated granulated activated carbon. As water passes through the first chamber and comes into contact with the particles therein, the contaminants within the water are absorbed thereby purifying the water. A seep-through membrane separates the particles in the first chamber from the particles in a second chamber of the cartridge.

In some embodiments, the second chamber and subsequent chambers of the cartridge perform water enrichment including different types of mineralization. To do so, the second chamber contains particles of a single mineral or particles of a blend of minerals. As water comes into contact with the particles, a trace amount of the mineral becomes infused with the water. The longer the water is in contact with the mineral particles, the greater the amount of mineralization. The duration in which the water remains in the chamber is controlled by increasing or decreasing the size of the chamber to hold more or less mineral particles or by altering the seep-through membrane in a manner that increases or decreases the throughput of water through the chamber. Additional mineralization chambers may be included below the second chamber with each mineralization chamber separated by a seep-through membrane that keeps the mineral particles apart. Each such chamber can include different mineral particles to provide different combinations of water enrichment with different minerals and different quantities of mineralization.

To accommodate different user preferences, cartridges may be produced with chambers that contain different mineral particles or quantities of mineral particles. The different combinations and quantities can be used to alter the mineral content of the water, the taste of the water, the softness of the water, and the alkalinity of the water. In some embodiments, the cartridge chambers are configurable and include an outer threaded top and a complimentary inner threaded bottom so that the top of one chamber can screw into the bottom of another chamber thereby allowing the consumer to mix and match chambers with different mineral particles in order to control the enrichment process according to personal preferences.

After the water passes through the cartridge, the treated and enriched water is deposited into the lower reservoir. A preservation cartridge within the lower reservoir maintains the treated and enriched water by preventing growth of secondary organisms. In some embodiments, the preservation cartridge contains minerals, such as zeolites, that are toxic to algae and bacteria. In addition to the minerals that aid in the preservation of the water, the preservation cartridge may also contain other minerals that further contribute to the mineralization of the water as the water is stored in the lower reservoir. This can ensure that the water retains a certain percentage of mineral content, a certain pH, a certain softness, etc. where some of these properties may otherwise dissolve or lose concentration as the water sits in the lower water reservoir for long periods of time.

Water may be dispensed from the lower reservoir using the water dispensing tap valve. The dispensed water is the filtered, purified, and mineralized water. In some embodiments, the dispensed water is also magnetized using a magnet that is encased and located along the water dispensing tap valve.

Some embodiments enhance the water treatment and enrichment apparatus with optional water heating and cooling chambers, manual or automatic refill by means of a water inlet shut off valve, a filter replacement timer, a pH level indicator, and an electrical power line plug-in chord of the type common for use in residential or commercial household electrical systems.

### BRIEF DESCRIPTION OF THE DRAWINGS

In order to achieve a better understanding of the nature of the present invention a preferred embodiment of the multi-stage water treatment and enrichment method and apparatus will now be described, by way of example only, with reference to the accompanying drawings in which:

FIG. 1 illustrates the multi-stage water treatment and enrichment apparatus in accordance with some embodiments.

FIG. 2 illustrates the components of FIG. 1 from an exploded view.

FIG. 3 provides an angled view of the collection area in accordance with some embodiments.

FIG. 4 shows the chamber separating seep-through membranes of some embodiments.

FIG. 5 presents a process for the treatment and enrichment method performed by the multi-stage water treatment and enrichment apparatus in accordance with some embodiments.

FIG. 6 illustrates configurable chambers of a customizable cartridge in accordance with some embodiments.

FIG. 7 illustrates a pH indicator in accordance with some embodiments.

FIG. 8 illustrates a water inlet with shutoff valve for use with the multi-stage water treatment and enrichment apparatus of some embodiments.

### DETAILED DESCRIPTION OF THE INVENTION

In the following detailed description of the invention, numerous details, examples, and embodiments of the multi-stage water treatment and enrichment method and apparatus are set forth and described. However, it will be clear and apparent to one skilled in the art that the multi-stage water treatment and enrichment method and apparatus is not limited to the embodiments set forth and that the method and apparatus may be practiced without some of the specific details and examples discussed.

I. Multi-Stage Water Treatment and Enrichment Apparatus

The multi-stage water treatment and enrichment apparatus overcomes many of the shortcomings of other personal water filtration systems by (1) providing an inexpensive apparatus that is suitable for primary usage in the home, (2) providing multiple levels of treatment including filtration and purification, (3) providing enrichment of water via mineralization, magnetization, softening, and alkalinization, (4) providing an apparatus that operates using gravitational forces and without the need for external power or pressure to perform the multi-stage treatment and enrichment of water, and (5) providing for customizability of the treatment and enrichment so that different consumers can adapt these processes to satisfy their own personal preferences.

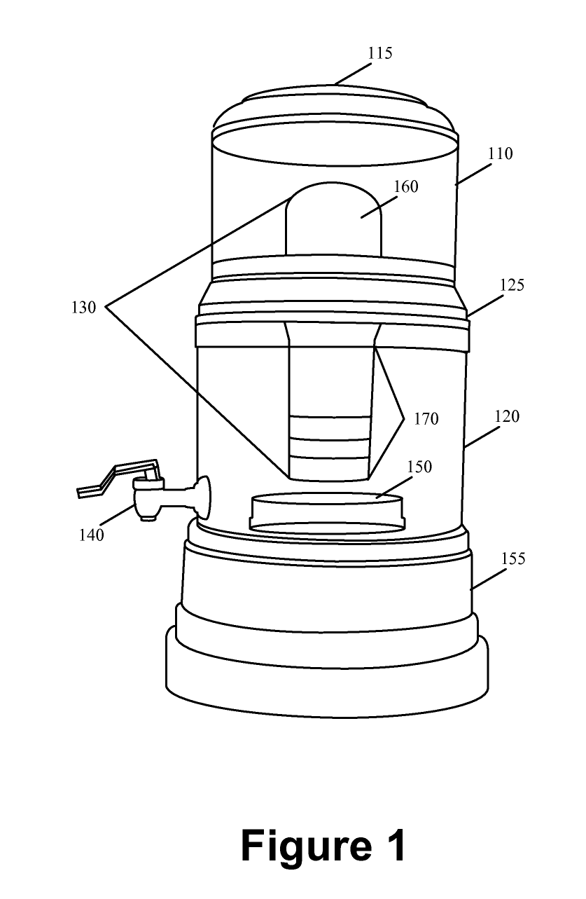

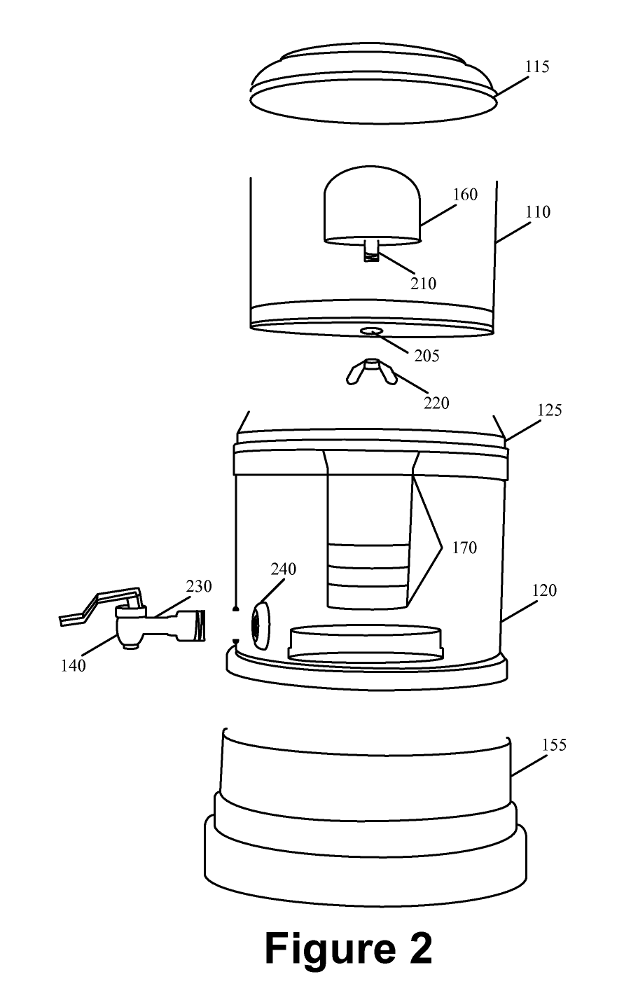

FIG. 1 illustrates the multi-stage water treatment and enrichment apparatus in accordance with some embodiments. The apparatus includes an upper water reservoir 110, a lid 115, a lower water reservoir 120, a collection area 125, a treatment and enrichment cartridge 130, a water dispensing tap valve 140, a preservation cartridge 150, and a base 155. The treatment and enrichment cartridge 130 is comprised of a dome ceramic filter 160 and multiple chambers 170. These components will be discussed in combination with FIG. 2 that illustrates the components 110-170 from an exploded view.

The upper water reservoir 110 and the lower water reservoir 120 are made from BPA free or petroleum free resin composites. The upper water reservoir 110 and lower water reservoir 120 are cylindrical in shape and each hold between one quart to two gallons of water depending on the overall size of the apparatus. In a preferred embodiment, the upper water reservoir 110 and the lower water reservoir 120 each hold a gallon of water. In light of the description below, it will be apparent to one of ordinary skill in the art that the upper water reservoir 110 and lower water reservoir 120 can be made in any shape (e.g., rectangular) and size to hold different amounts of water without affecting the overall utility, functionality, and operation of the water treatment and enrichment apparatus for the embodiments described herein. The lower water reservoir 120 is placed atop the base 155. As shown, the base 155 is suitable for placing the apparatus on a counter top. However, the base 155 can be made taller in order to accommodate placing the base 155 at ground level. In some embodiments, the upper water reservoir 110 is secured to the lower water reservoir 120 with a clasping mechanism that forms a water tight seal between the reservoirs.

The removable lid 115 acts to cover the upper face of the upper water reservoir 110. In some embodiments, the lid 115 contains inner screw threading that couples to outer screw threading that is located along the outer side of the upper face of the upper water reservoir 110. In some such embodiments, the lid 115 screws onto the upper face of the upper water reservoir 110 to form an airtight seal that prevents dust or other particles from entering into the upper water reservoir 110. The lid 115 is removed to allow untreated water, tap water, well water, rain water, reclaimed water, reuse water, or other types of water to be poured into the upper water reservoir 110 for treatment and enrichment in accordance with some embodiments.

In some embodiments, near the center of the bottom face of the upper water reservoir 110 is a lowered base section with a circular opening 205. In some other embodiments, the bottom face is angled downward from the outer edges toward the circular opening 205 near the center. These constructions make the center of the bottom face of the upper water reservoir 110 lower than the outer edges, allowing gravitational force to pull water towards the circular opening 205.

A. Filtration

As shown in FIG. 2, the ceramic dome filter 160 includes a stem 210 with outer screw threading that fits into the circular opening 205 of the upper water reservoir 110. The ceramic dome filter 160 is secured to the upper water reservoir 110 by inserting the threaded stem 210 through the circular opening 205 and by securing the filter 160 to the reservoir 110 by screwing a wing shaped hand nut 220 that contains inner screw threading to the stem 210. As water is poured into the upper water reservoir 110, gravity forces the water towards the ceramic dome filter 160.

The ceramic dome filter 160 has a dome-shaped hollow porous ceramic outer surface and a hollow inner cavity. Water permeates through the pores of the ceramic dome filter 160 into the hollow inner chamber where it accumulates and passes through the stem 210. The act of water permeating through the pores performs water filtration. In a preferred embodiment, each pore along the surface of the ceramic dome filter 160 is 0.2 microns in size. Pores of this size have been shown to effectively trap and eliminate 99% to 100% of most water-borne disease agents, pathogens, or other microorganisms (e.g., bacteria and parasites). This is because many such microorganisms are 0.5 microns and greater in size. Accordingly, they are unable to pass through the pores of the dome's outer surface and are thus trapped along the outer surface. Water, however, does pass through the pores. Consequently, water from which larger contaminants have been filtered away enters into the hollow inner cavity of the ceramic dome filter 160. In some other embodiments, the pores of the ceramic dome filter 160 range in size from 0.1-0.4 microns. Smaller sized pores provide greater filtration albeit with lesser water throughput through the pores of the filter 160. Larger sized pores provide lesser filtration albeit with greater water throughput through the pores of the filter 160. In some embodiments, the filter 160 is 3.5 inches in height and 4 inches in diameter along the base. It should be apparent to one of ordinary skill in the art that the ceramic dome filter 160 can be made in different sizes and shapes. The dome shaped is selected to expose a maximum surface area to the water that is poured into the upper water reservoir 110.

In contrast to many water filtration systems that provide some form of filtration, the ceramic dome filter 160 that is used in accordance with some embodiments is reusable. Specifically, the filter 160 may be decoupled from the upper water reservoir 110 at periodic intervals and scrubbed clean to remove contaminants that have been trapped along the outer surface. Cleaning may be performed using scouring pads or finely bristled brushes. In some embodiments, the ceramic dome filter 160 includes multiple ceramic layers that are baked into the dome shape. Scrubbing one layer removes contaminants that have been trapped in that layer and exposes a clean unclogged layer. Depending on the scrubbing force and the coarseness of the pad or brush, the ceramic dome filter 160 can be reused for several months or years without loss in filtration effectiveness.

As the filtered water passes through the stem 210 of the ceramic dome filter 160, it enters a collection area 125 that is placed between the upper water reservoir 110 and the lower water reservoir 120. The cartridge chambers 170 couple to and are held in place by the collection area 125. Gravity forces the filtered water down to the center of the collection area 125 and through the cartridge chambers 170.

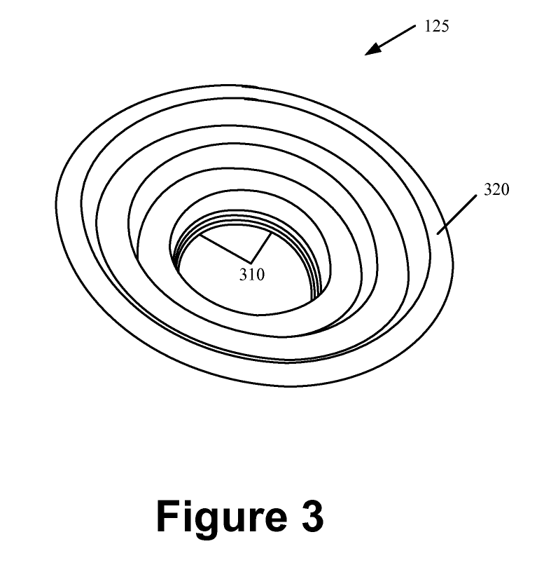

FIG. 3 provides an angled view of the collection area 125 in accordance with some embodiments. As shown, the collection area 125 is a tiered conical plate with a screw threaded circular opening 310 towards the center. The outermost tier 320 (i.e., the outer lip) is of the circumference of the upper face (i.e., top) of the lower water reservoir 120 and thus fits atop the upper face of the lower water reservoir 120. To couple the cartridge chambers 170 to the collection area 125, the first cartridge chamber has outer screw threading that screws into the screw threaded circular opening 310 of the collection area 125. In some embodiments, the collection area 125 is omitted. In some such embodiments, the cartridge chambers 170 directly screw onto and couple to the threaded stem 210 of the ceramic dome filter 160 such that filtered water passing through the stem 210 directly enters the cartridge chambers 170. In this manner, the water treatment and enrichment occurs using a single unit that has no intermediary parts.

B. Purification

In some embodiments, the cartridge chambers 170 treat and enrich the water. Each chamber contains a plurality of solid particles from the same element or different elements. When the particles come into contact with water, the particles either treat or enrich the water.

In some embodiments, the first chamber is a purification chamber for additional treatment of the filtered water passing from the ceramic dome filter 160. The purification chamber contains silver impregnated granulated activated carbon particles also known as silver impregnated activated charcoal. It is well known in the art that activated carbon acts to purify water that comes into contact with it. Specifically, the activated carbon has molecular properties that chemically bond with or absorb various contaminants in water such as chlorine, pigments, odors, color, detergents, carcinogens (e.g., trihalomethanes), agricultural chemicals, heavy metals, and other impurities. As noted above, the activated carbon may be impregnated with other elements to improve the purification process. In some embodiments, the activated carbon is impregnated with colloidal silver. Colloidal silver has an oligodynamic effect and acts as an antiseptic and disinfectant that is toxic for and kills algae, bacteria, and fungi.

In some embodiments, the first chamber is 2 inches in height and 3 inches in diameter and is filled with the silver impregnated granulated activated carbon particles. The first chamber can be made smaller or larger in size when less or greater purification is needed. For example, a larger chamber will contain more silver impregnated granulated activated carbon particles and the water passing through the chamber will make contact with more particles thereby resulting in better purification. In addition to or instead of the silver impregnated granulated activated carbon, other particles may be used to perform water purification. Accordingly, the first chamber may contain other particles besides silver impregnated granulated activated carbon or a second chamber may be added below the first chamber to include other purification particles. For example, ion exchange resins have been shown to have water purification properties and can therefore be used in addition to or instead of the aforementioned silver impregnated granulated activated carbon. Moreover, the first chamber may be modified to include activated carbon particles in combination with ion exchange resins.

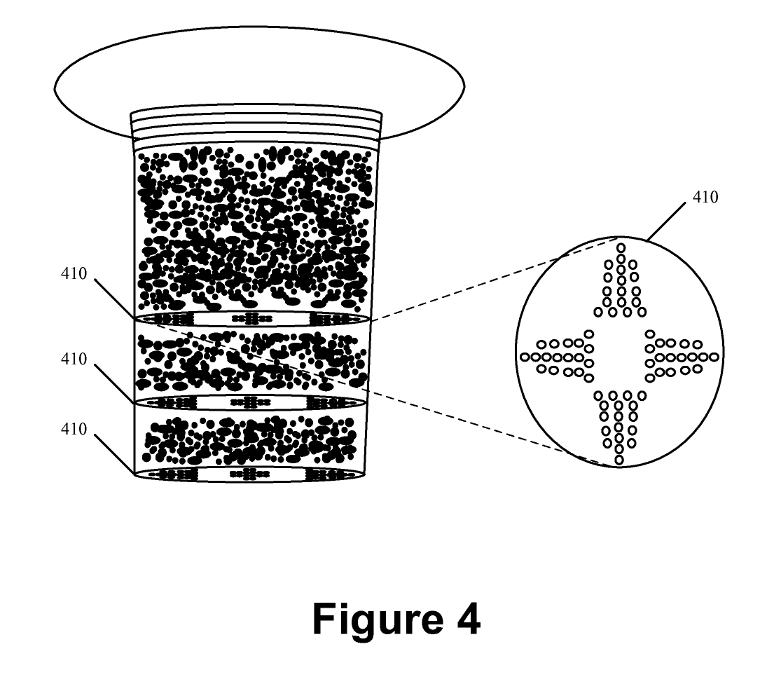

A seep-through membrane separates each of the chambers 170 from one another. Specifically, the seep-through membrane is a disk that separates solid particles of one chamber from different solid particles of another chamber. The seep-through membrane also serves as a means to control the throughput of water from one chamber to another chamber. As shown in FIG. 4, each of the separating seep-through membranes 410 contains a pattern of holes. Depending on the size of the holes and the number of holes, the throughput of water through the chambers is regulated. Different chambers can have different seep-through membranes to regulate the throughput of water through the chambers differently.

C. Mineralization

In some embodiments, the second chamber and subsequent chambers thereafter perform water enrichment. As above, each of the second chamber and subsequent chambers is separated with a seep-through membrane that keeps the solid particles of one chamber separate from the particles of an adjacent chamber.

One form of enrichment includes water mineralization. To perform water mineralization, the second chamber may be filled with particles of one or more minerals. As the filtered and purified water passes from the first chamber through a seep-through membrane into the second chamber, the water comes into contact with the mineral particles of the second chamber. When in contact, a trace amount of minerals is removed from the mineral particles and infused with the water thereby enriching the water with these minerals.

In some embodiments, the second chamber and subsequent chambers are 0.5 inches in height and 3 inches in diameter. The chambers can be made larger or smaller depending on the amount of enrichment desired. For instance, if the second chamber is 1 inch in height, the second chamber will contain a greater number of mineral particles that come into contact with the water, thereby infusing a greater number of minerals into the water. Additionally, the amount of enrichment can be controlled by altering the size of the holes and the number of holes of each of the separating seep-through membranes.

Some minerals have been shown to provide health benefits when ingested (e.g., potassium, calcium, magnesium, iodine, selenium, zinc, etc.). Some minerals are believed to provide health benefits, but have not yet been scientifically proven (e.g., minerals having bio-energy properties). Minerals can also be used to the softness or hardness of water or the alkalinity of water. For example, water that has not been enriched with minerals measures with a pH of 7.0-7.5, and the same water when enriched with three chambers of distinct minerals using the apparatus of some embodiments measures with a pH of 8.9-9.2. Still some minerals provide benefits that are subjective to the consumer such as altering the taste of the water.

Any combination of minerals can be stored in individual or separate chambers of the cartridge 130. For example, the second chamber may contain far infrared balls to impart bio-energy properties into the water, a third chamber may contain silica sand to aid in the absorption of dietary nutrients, and a fourth chamber may contain ion exchange resins to soften and decluster the water. The cartridge chambers can be filled with particles of any other mineral (e.g., calcium, potassium, etc.) based on manufacturer preferences or, as will be described below, based on consumer preferences. After regular usage, the mineral solids in each of the chambers will have dissolved and will need to be replaced with the purchase of a new cartridge or cartridge chambers (e.g., after 6-8 months of regular 5 gallon per day usage).

In some embodiments, other forms of enrichment may be achieved by varying the content of the cartridge chambers. For example, in addition to or instead of mineral particles, some embodiments allow particles of vitamin solids to be placed in one or more of the chambers so as to provide vitamin enriched water. In this manner, consumers can ingest their daily vitamins by simply drinking water that has been enriched using the apparatus of some embodiments.

D. Magnetization

Once the water has passed through the various chambers of the cartridge, the treated and enriched water is deposited in the lower water reservoir 120 and is available to drink. The apparatus includes the water dispensing tap valve 140 to dispense the water from the lower water reservoir 120. When the handle of the tap valve 140 is pulled, water is allowed to flow from the lower water reservoir 120 out through the tap valve 140.

In some embodiments, the tap valve 140 performs further enrichment of the water. Specifically, by encasing a magnet in the tap valve 140, the water is magnetized as it is dispensed. Magnetization declusters the water for better absorption by the body and has been claimed to aid in treating digestive, nervous, urinary disorders, and chronic degenerative diseases.

As shown in FIG. 2, the tap valve 140 is composed of at least two separable parts. The first part 230 comprises a protruding dispensing tip, control handle, valve assembly that opens and closes the flow of water based on the position of the handle, and an outer threaded end that is inserted into a circular hole located along an outward facing side of the lower water reservoir 120. The first part 230 is secured to the lower water reservoir 120 with an inner threaded nut that is the second part 240 of the tap valve 140. When the nut is screwed to the first part 230, a water tight seal is formed preventing water from seeping through the hole that is located along the outward facing side of the lower water reservoir 120. In some embodiments, encased within the outer plastic shell of the nut (i.e., second part 240) is a circular magnet. In some such embodiments, the water does not directly come into contact with the magnet, because it is shielded from the magnet by the outer shell of the nut. However, when the water is dispensed, it passes through the magnet and at that time is magnetized. Most commercially magnetized water loses its magnetization properties by the time it is brought to market and sold to the consumer as the magnetization properties last for a short duration of time (e.g., 30 minutes to an hour). However, by magnetizing the water directly as it is dispensed, the magnetization properties will be present when ingested by the consumer. The encased magnet may be a variety of different types and strengths of magnets.

E. Preservation

A common issue with many personal water filtration systems is that once the water is treated and deposited within a storage reservoir, there is no manner by which the quality of the water is preserved. Organic contaminants may be introduced by secondary growth of pathogens, bacteria, algae, or fungi. This secondary growth may be expedited when the storage reservoir is exposed to sunlight, warm temperatures, or other factors that facilitate the growth of organic contaminants. Additionally, the storage reservoir itself may be contaminated so that once treated water is deposited within the storage reservoir, the contaminants from the storage reservoir adversely affect the quality of the water. The storage reservoir may become contaminated when it is not washed regularly. To overcome these issues and other similar issues that affect the quality of the treated and enriched water within the lower water reservoir 120, some embodiments provide the preservation cartridge 150.

In some embodiments, the preservation cartridge 150 contains various minerals that inhibit and restrain the breeding and growth of secondary organic contaminants such as bacteria and algae. These minerals may include zeolites or other mineral stones that contain properties that are toxic to various organic contaminants. The preservation cartridge 150 is located at the base of the lower water reservoir 120 and contains slits that allow the minerals to contact the treated and enriched water in the lower water reservoir 120. The mineral stones can be used with or without the mineral contain case. In this manner, the freshness and quality of the water is maintained over longer periods of time than with traditional personal water filtration systems that provide no such preservation process. For this reason, the lower water reservoir 120 can be larger and store more treated and enriched water. Consequently, treated and enriched water is more readily available and refilling the reservoirs occurs less frequently than with other personal water filtration systems.

The preservation cartridge 150 may also be enhanced with other minerals that further treat or enrich the water when the treated and enriched water is stored in the lower water reservoir 120. For example, in some embodiments, the preservation cartridge 150 includes a plurality of different inorganic minerals other than the above described preservation minerals (e.g., zeolites). These other inorganic minerals may include the aforementioned far infrared ceramic balls, silica sand, or other mineral stones with similar enrichment characteristics and functionalities. By including these other mineral solids in the preservation cartridge 150, the preservation cartridge 150 can be used to ensure that the water in the lower water reservoir 120 retains a certain percentage of mineral content, a certain pH, a certain softness, etc. where some of these properties may otherwise dissolve or lose concentration as the water sits in the lower water reservoir 120 for long periods of time. Accordingly, the preservation cartridge 150 is used in some embodiments to not only maintain the purity of the water, but also the enrichment of the water.

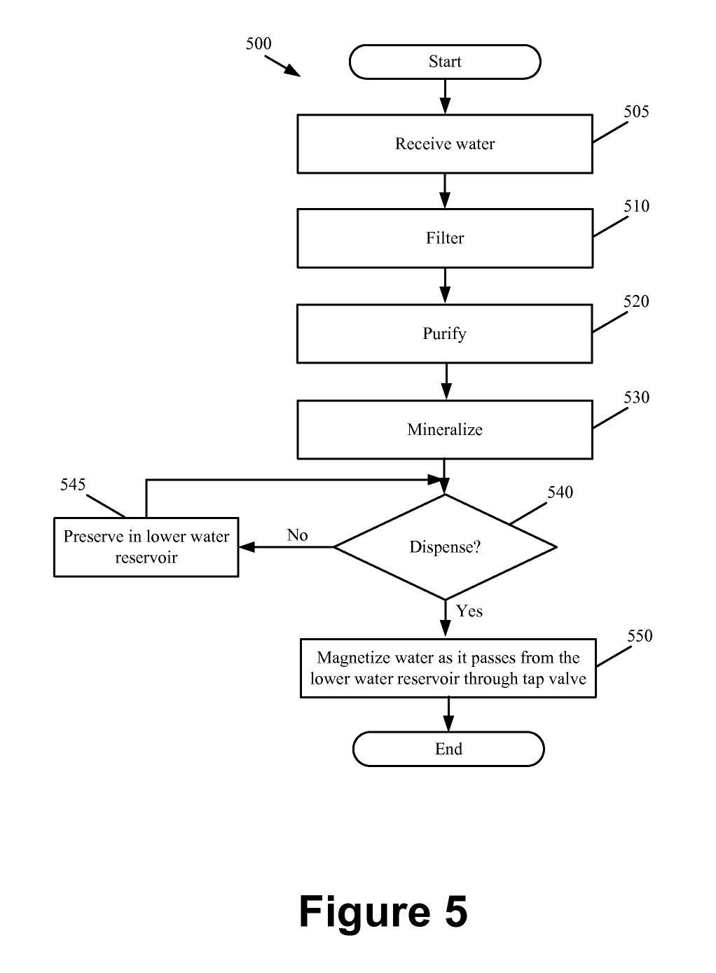

FIG. 5 presents a process 500 for the treatment and enrichment method performed by the multi-stage water treatment and enrichment apparatus in accordance with some embodiments. The process 500 begins when water, such as tap water, well water, rain water, reclaimed water, reuse water, or other types of water is poured into and received at (at 505) the upper water reservoir. The process treats the water by filtering (at 510) contaminants from the water as the water passes through the ceramic dome filter. Further treatment includes purifying (at 520) the water by passing the water through the cartridge chamber that contains the silver impregnated granulated activated carbon particles.

Next, the process enriches the water. Specifically, the process mineralizes (at 530) the water by passing it through one or more chambers that contain various mineral particles. The water is then deposited in the lower water reservoir where it is available for consumption. Should the water be dispensed (at 540), the water is magnetized (at 550) as it passes from the lower water reservoir through the tap valve and the process ends. Otherwise, the treated and enriched water is preserved (at 545) within the lower water reservoir until it is dispensed.

II. Cartridge Customization

An advantage of the multi-stage treatment and enrichment apparatus over current personal water filtration system is that the treatment and enrichment can be personalized according to the preferences of the consumer. This allows the consumer to control and modify the mineral content, softness, alkalinity, and taste of the water according to his/her preferences. In some embodiments, manufacturers produce cartridges with different numbers of chambers and different particles in each of the chambers in order to affect the properties of the treated and enriched water. Accordingly, consumers can purchase and try different cartridge configurations to identify a preferred configuration. In some other such embodiments, consumers can contact the manufacturer via telephone, internet, or other communication means to specify a desired configuration (e.g., number of chambers, mineral content of each chamber, etc.) and the manufacturer provides the customized cartridge to the consumer.

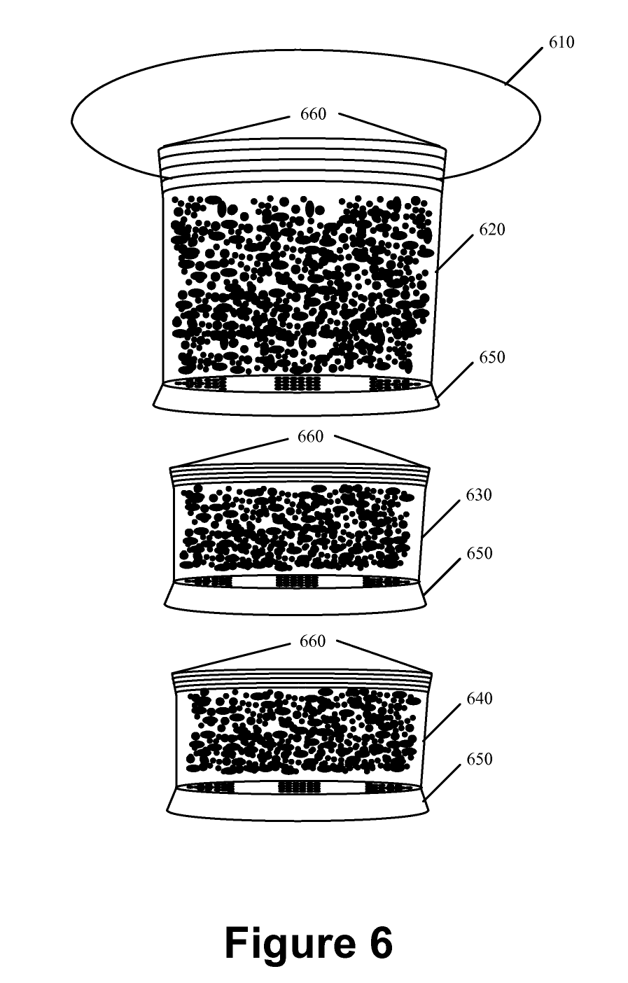

In some embodiments, the cartridge is consumer configurable by providing a customizable cartridge whereby different chambers can be added, removed, or reordered by screwing one chamber underneath another chamber. FIG. 6 illustrates configurable chambers of a customizable cartridge in accordance with some embodiments. The configurable chambers include a first chamber 620, a second chamber 630, and a third chamber 640. It should be noted that any number of chambers containing different mineral particles can be used in conjunction with the customizable cartridge. As shown, each of the chambers 620-640 includes outer screw threading 660 at the top of the chamber and inner screw threading 650 at the bottom of the chamber. In this manner, any of the chambers can be coupled to the collection area 610. Furthermore, any one chamber can be coupled to any other chamber. Consumers can thus modify the order of the chambers and modify which chambers are used to treat and/or enrich the water. For example, some consumers may prefer to include a chamber containing calcium mineral particles and other consumers instead may prefer to include a chamber containing potassium mineral particles as part of the cartridge configuration. In some embodiments, up to 6 distinct chambers may be coupled as part of the cartridge that treats and enriches the water.

In some embodiments, the chambers may also be customized in relation to the ratio or density of the treatment or enrichment. This includes attaching chambers that contain fewer or greater quantities of a particular mineral so that the water contacts fewer or greater number of the mineral particles. This also includes altering the size and number of holes in the seep-through membrane that controls the throughput of water through the chamber. As the holes increase in size and the number of holes are increased, the greater the throughput of water through the chamber. This results in less treatment or enrichment as the water spends less time contacting the particles in the chamber. Accordingly, some embodiments allow consumers to purchase chambers with different sized seep-through membranes that regulate the treatment or enrichment of water differently.

III. Other Enhancements

The multi-stage water treatment and enrichment apparatus can be modified to include any number of additional enhancements that improve upon the convenience afforded by the apparatus and the features of the apparatus. Some embodiments enhance the apparatus to include an extended base, water-tight and air-tight locking mechanism, optional water warmer and/or cooler, manual or automatic refill by means of a built-in water inlet shut off valve, a filter replacement timer, a pH level indicator, and an electrical power line plug-in chord of the type common for use in residential or commercial household electrical systems.

In some embodiments, the base 155 of FIG. 1 is interchangeable with different bases of different heights. This adapts the water treatment and enrichment apparatus for different placement and use. For example, the apparatus can be adapted for counter top placement using a first shorter base and adapted for free standing placement on the floor using a second taller base. As such, the apparatus can be adapted for use in home, on-the-go portable use, in an office, or other commercial setting.

As earlier noted, the upper water reservoir 110 may be secured to the lower water reservoir 120 with a clasping mechanism that forms a water-tight and air-tight seal between the reservoirs. The clasping mechanism may include a clasp at one of reservoirs and a latch at the other reservoir that interlock to form the water-tight and air-tight seal. Additionally, the lid can be attached to the upper water reservoir 110 using inner and outer screw threading to create a water-tight and air-tight seal at the top. These seals prevent outside contaminants such as dust and pollen from entering into either of the reservoirs thereby preserving the quality of the water.

To provide instant cold water, the base of the apparatus can be modified to include a stainless water tank in the base that performs compressor cooling of the water, similar to those used in traditional water coolers, and which can be activated by means of an externally mounted button, switch, lever or other similar selection feature. An electrical power line plug-in chord extends from the compressor to an outlet in order to power the compressor. The water cooler receives treated and enriched water from the lower water reservoir and dispenses chilled water through the tap valve when the appropriate button is pressed or lever is pulled. Similarly, a heating chamber or heat tank can also be embodied within the overall system. The heating chamber stores water in a heated state or flash heats the water as it passes from the lower water reservoir through the heating chamber out through the tap valve. Heated water from the heating chamber may be selected as an option by the user by means of an externally mounted button, switch, lever or other similar selection feature.

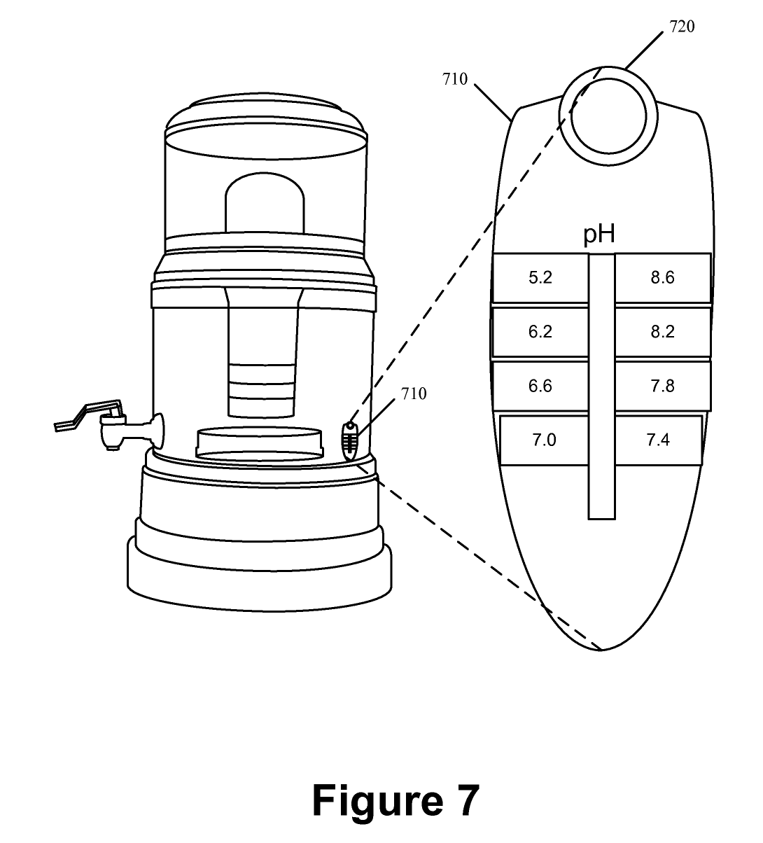

Some embodiments of the apparatus are enhanced to include a pH indicator on the interior of the lower water reservoir to indicate the alkalinity level of the water. This indicator will provide visual evidence that the minerals in the cartridge chambers can increase the pH level of the water to around a pH of 8.9 which is considered to be healthy. FIG. 7 illustrates a pH indicator 710 in accordance with some embodiments. The pH indicator 710 includes a suction cup 720 to attach it to a side of the lower water reservoir. When exposed to the treated and enriched water in the lower water reservoir, pH measurements are performed to indicate the pH of the water.

Some embodiments of the apparatus are enhanced to include a date counter which, in the preferred embodiment, is disposed on the front part of the top lid to serve as a reminder to a user that one or more cartridge chambers or filters need to be replaced. This is to ensure optimum performance of the system. The date counter may digitally display information including but not limited to, date, time, month, day, hour, minute, filter indicator light or symbol, and may further embody control buttons such as reset button, time/date set button, and may embody other buttons or digital display information.

Some embodiments of the apparatus are enhanced to include a water inlet with shutoff valve which connects to a water line (e.g., from the sink or refrigerator). This feature will allow users to conveniently fill in water automatically and eliminates the need for manual filling.

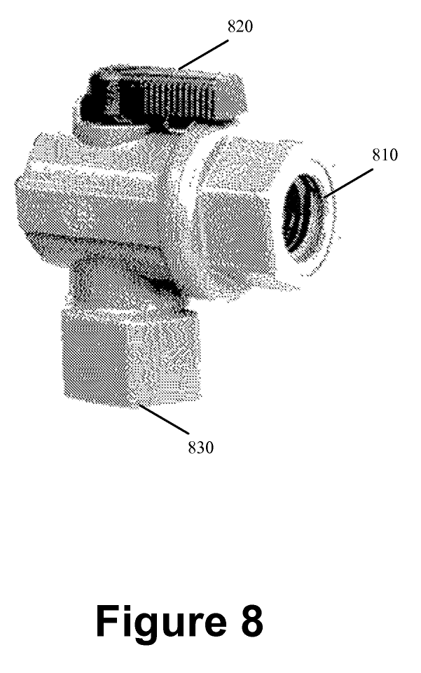

FIG. 8 illustrates a water inlet with shutoff valve for use with the multi-stage water treatment and enrichment apparatus in accordance with some embodiments. The water inlet with an open and shutoff valve includes a first end 810, a valve 820, and a second end 830. The first end 810 is secured to an active water line. The second end 830 is inserted into an opening in the top lid of the upper water reservoir. The inlet can be secured to the top lid with a nut and screw assembly. The valve 820 regulates the flow of water into the upper water reservoir. When the valve 820 is opened, water pours from the water line into the upper water reservoir. When the valve 820 is closed, no water passes through the inlet. Using the inlet, users no longer have to transport the apparatus or upper water reservoir to a faucet in order to fill the upper water reservoir with water. Instead, whenever water is needed, the valve can be opened and water will fill the upper water reservoir.

Further enhancements include automating the opening and closing of the valve 820. To do so, the valve is electronically or magnetically controlled with a sensor that is located in the lower water reservoir. The sensor determines the water level in the lower water reservoir. When the water level falls below a threshold amount, the sensor sends an electric pulse to open the flow of water through the valve. When the sensor detects that the water level in the lower water reservoir is at a sufficient level or a sufficient amount of time has elapsed, the sensor sends a different electrical pulse to shutoff the valve and stop the flow of water into the upper water reservoir.

While the multi-stage water treatment and enrichment method and apparatus has been described with reference to numerous specific details, one of ordinary skill in the art will recognize that the method and apparatus can be embodied in other specific forms without departing from the spirit of the invention. Specifically, the apparatus and its various components may be manufactured in a variety of sizes from a portable hand held embodiment to a free standing countertop embodiment, a free standing with base embodiment such as those commonly found in offices or residential homes, as well as other size and application embodiments not referred to herein, with each embodiment performing the intended use and function disclosed herein and is therefore to be considered apparent to the disclosure contained herein. Thus, one of ordinary skill in the art would understand that the invention is not to be limited by the foregoing illustrative details, but rather is to be defined by the appended claims.

We claim:

1. A water treatment and enrichment apparatus comprising:
a first water reservoir for receiving water that is to be treated and enriched;
a second water reservoir for storing treated and enriched water; and
a cartridge through which water from the first water reservoir is treated and enriched before being deposited in the second water reservoir, wherein the cartridge comprises at least (i) a first chamber for purifying water to remove contaminants from the water in the first water reservoir and (ii) a second chamber for enriching water passing from the first chamber with at least one mineral.

2. The water treatment and enrichment apparatus of claim 1 further comprising a ceramic filter with a porous outer surface and a hollow inner cavity, said porous outer surface comprising a plurality of pores that are less than 0.4 microns in size and that filter contaminants from water in the first water reservoir by preventing passage of said contaminants through the outer surface into the hollow inner cavity, wherein filtered water from the inner cavity flows to the first chamber of said cartridge.

3. The water treatment and enrichment apparatus of claim 1 further comprising a tap valve for dispensing water from the second reservoir for drinking, wherein the tap valve comprises a magnet through which water passes through when being dispensed, said magnet for magnetizing the water as it is dispensed.

4. The water treatment and enrichment apparatus of claim 1 further comprising a preservation cartridge for preserving the quality of the water in the second water reservoir by inhibiting growth of microorganisms, wherein the preservation cartridge comprises (i) particles of a mineral that are toxic to said microorganisms and (ii) a plurality of openings through which water contacts said particles.

5. The water treatment and enrichment apparatus of claim 4, wherein the mineral comprises at least one of zeolites and other mineral stones that contain properties that are toxic to organic contaminants.

6. The water treatment and enrichment apparatus of claim 1, wherein the first chamber comprises a plurality of activated carbon particles that purify water that comes into contact with said activated carbon particles, and wherein the second chamber comprises a plurality of particles of a mineral from which an amount of the mineral is infused with water that comes into contact with said mineral particles.

7. The water treatment and enrichment apparatus of claim 6, wherein the amount of the mineral that is infused with the water modifies at least one of alkalinity of the water, taste of the water, and softness of the water.

8. The water treatment and enrichment apparatus of claim 6, wherein the mineral particles are particles of a first mineral, wherein the cartridge further comprises a third chamber comprising a plurality of particles of a second mineral from which an amount of the second mineral is infused with water that comes into contact with said particles of the second mineral, wherein the first mineral is different than the second mineral.

9. The water treatment and enrichment apparatus of claim 6, wherein the particles of the first chamber are separated from particles of the second chamber with a seep-through membrane that regulates throughput of water through the first chamber.

10. The water treatment and enrichment apparatus of claim 6, wherein the mineral in the second chamber comprise at least one of silver impregnated granulated activated carbon, ionic-exchange resin, far infrared ceramic balls, silica sand, zeolites, and mineral stones that enrich water coming into contact with said mineral stones.

11. The water treatment and enrichment apparatus of claim 1, wherein the cartridge comprises a plurality of chambers that are interchangeable, wherein each chamber of the plurality of chambers comprises outer screw threading at a first end and inner screw threading at a second end whereby any one chamber can be coupled to any other chamber in any order by screwing the first end of one chamber into the second end of another chamber, wherein each chamber of the plurality of chambers further comprises a plurality of particles of different minerals.

12. A method for treating and enriching water with a multi-stage water treatment and enrichment apparatus, the method comprising:
receiving water in a first water reservoir that is coupled with a filter having a porous outer surface and a hollow inner cavity;
filtering said water by trapping contaminants in the water against the outer surface of said filter while water permeates through the outer surface into said hollow inner cavity;
passing said water from the hollow inner cavity through a first chamber comprising a plurality of purification particles that remove contaminants from said water as said water comes into contact with said purification particles in the first chamber;
passing said water from the first chamber through at least a second chamber, wherein the second chamber comprises a plurality of particles of a first mineral that enrich said water with the first mineral as said water comes into contact with the particles in the second chamber; and
preserving said water with particles of a second mineral that are toxic to microorganisms, wherein the particles of the second mineral are contained in a second water reservoir that receives water from the second chamber.

13. The method of claim 12 further comprising dispensing said water from the second water reservoir through a magnetized tap valve that magnetizes said water as it is dispensed.

14. The method of claim 12 further comprising passing said water from the second chamber through a third chamber, wherein the third chamber comprises a plurality of particles of a third mineral that enrich said water with the third mineral as said water comes into contact with the particles in the second chamber.

15. A configurable cartridge for use in treating and enriching water in conjunction with a personal water treatment and enrichment apparatus, said cartridge comprising:
a first set of chambers, each chamber of the first set of chambers containing a plurality of purification particles that remove contaminants from water that comes into contact with the purification particles, each chamber of the first set of chambers comprising outer screw threading on a first end and inner screw threading on a second end; and
a second set of chambers, each chamber of the second set of chambers containing a plurality of enrichment particles of a particular mineral that are used to enrich water with the particular mineral when water comes into contact with the enrichment particles, each chamber of the second set of chambers comprising outer screw threading on a first end and inner screw threading on a second end,
wherein any chamber of the first set of chambers and second set of chambers can be coupled to another chamber by screwing the first end of one chamber to the second end of another chamber such that treatment and enrichment of water provided by said personal water treatment and enrichment apparatus is customized.

16. The configurable cartridge of claim 15, wherein the configurable cartridge configured with different combinations of chambers from the second set of chambers produces different levels of enrichment that modify at least one of mineral content of the water, alkalinity of the water, and softness of the water.

17. The configurable cartridge of claim 15 further comprising a porous filter that is used in combination with the first and second sets of chambers, said porous filter comprising a plurality of pores for filtering contaminants from water passing through the porous filter.

18. The configurable cartridge of claim 15, wherein each chamber of the first set of chambers contains at least one of activated carbon particles, silver impregnated granulated activated carbon particles, and ion exchange resins.

19. The configurable cartridge of claim 18, wherein each chamber of the second set of chambers contains at least one of silver impregnated granulated activated carbon, ionic-exchange resin, far infrared ceramic balls, silica sand, zeolites, and mineral stones that enrich water coming into contact with said mineral stones.

20. The configurable cartridge of claim 15, wherein the plurality of enrichment particles of a chamber of the second set of chambers modifies at least one of mineral content in water, alkalinity of water, and softness when water comes into contact with the enrichment particles.

21. The configurable cartridge of claim 15 further comprising a third set of chambers that can be coupled in any combination with chambers of the first and second sets of chambers, wherein a chamber of the third set of chambers contains a plurality of enrichment particles of a particular vitamin that are used to enrich water with the particular vitamin when water comes into contact with the enrichment particles, and wherein said chamber of the third set of chambers comprises outer screw threading on a first end and inner screw threading on a second end.
